(19) United States
(12) Patent Application Publication
(10) Pub. No.: US 2024/0339633 A1
(43) Pub. Date: Oct. 10, 2024

(54) ULTRA-LIGHT BIPOLAR PLATE FOR FUEL CELL, MANUFACTURING METHOD THEREOF, AND FUEL CELL INCLUDING SAME

(71) Applicant: ILDO F&C CO., LTD., Incheon (KR)

(72) Inventors: Seong Hwa CHO, Seoul (KR); Jung Seok YI, Seongnam-si (KR); Joong Hyung PARK, Incheon (KR); Shin cheon YUN, Gimcheon-si (KR)

(73) Assignee: ILDO F&C CO., LTD., Incheon (KR)

(21) Appl. No.: 18/599,214

(22) Filed: Mar. 8, 2024

(30) Foreign Application Priority Data
Apr. 4, 2023 (KR) 10-2023-0043891
May 11, 2023 (KR) 10-2023-0061013

(51) Int. Cl. H01M 8/0221; H01M 4/88; H01M 8/0228

(52) U.S. Cl. CPC H01M 8/0221; H01M 4/8875; H01M 8/0228

(57) ABSTRACT

The present disclosure relates to an ultra-light bipolar plate for a fuel cell, including a carbon fiber fabric layer made of one or more prepreg sheets and a graphite-resin composite layer coated and formed on at least one surface of the carbon fiber fabric layer so that electrical conductivity and mechanical strength are improved compared to conventional bipolar plates made of graphite material even when the ultra-light bipolar plate for a fuel cell is manufactured in the form of a thin plate, a manufacturing method thereof, and a fuel cell including the same.

### CROSS-REFERENCE TO RELATED APPLICATION

This application claims the priority benefit of Korean Patent Application Nos. 10-2023-0043891, filed on Apr. 4, 2023 and 10-2023-0061013 filed on May 11, 2023, which are hereby incorporated by reference in their entirety.

### BACKGROUND OF THE INVENTION

The present disclosure relates to an ultra-light bipolar plate for a fuel cell, a manufacturing method thereof, and a fuel cell including the same.

Generally, a fuel cell is formed in the form of a unit cell or a stack in which unit cells are stacked. The unit cell of the fuel cell consists of a membrane-electrode assembly (MEA) in which a reaction part is formed by bonding a fuel electrode and an air electrode for diffusing gas to both sides of the bipolar plate, a bipolar plate which is assembled to be in close contact with both sides of the membrane-electrode assembly so that a flow field for fuel gas and oxygen-containing gas put into the fuel electrode and the air electrode is formed therein, a gasket which is disposed on the edge of the bipolar plate to block leakage of fuel and air, and end plates or current collector plates which are disposed on both sides of the bipolar plate and serve as collection electrodes for the fuel electrode and the air electrode.

The bipolar plate is a plate-shaped component that separates the fuel electrode and the air electrode, and it accounts for 80% of the weight of the fuel cell, and its front surface is formed in a channel shape to perform an electrical conduction function between adjacent cells while providing a flow path for the reaction gas.

Meanwhile, although a metal substrate material with good mechanical strength against vibration, impact, or the like is generally used as the bipolar plate material used in mobility fuel cells, there has been a problem in that metal ions melt or an insulating oxide film is formed due to a corrosion reaction in the fuel cell environment. Accordingly, although a graphite-based composite material with excellent corrosion resistance and no oxide film formation is applied, it is difficult to apply it to land and aviation mobility fuel cells due to its thick thickness and high weight. Therefore, there is an urgent need for a method capable of overcoming the limitations of current graphite materials.

### PRIOR ART DOCUMENTS

### Patent Documents

(Patent Document 1) Korean Patent Publication No. 10-2005-0120515 (Dec. 22, 2005)
(Patent Document 2) Korean Patent No. 10-0864681 (Oct. 15, 2008)

### SUMMARY OF THE INVENTION

The present disclosure has been derived to solve the problems as described above, and an object of the present disclosure is to provide an ultra-light bipolar plate for a fuel cell, which has excellent electrical conductivity and mechanical strength even when manufactured in the form of a thin plate with a similar thickness to a conventional metal bipolar plate, and has significantly reduced thickness and weight compared to conventional graphite bipolar plates by coating and forming a graphite-resin composite layer on a carbon fiber fabric layer, a manufacturing method thereof, and a fuel cell including the same.

In order to achieve the above object, an ultra-light bipolar plate for a fuel cell according to one embodiment of the present disclosure includes a carbon fiber fabric layer made of one or more prepreg sheets and a graphite-resin composite layer coated and formed on at least one surface of the carbon fiber fabric layer so that electrical conductivity and mechanical strength may be improved compared to conventional bipolar plates made of graphite material even when the ultra-light bipolar plate for a fuel cell is manufactured in the form of a thin plate.

A method for manufacturing an ultra-light bipolar plate for a fuel cell according to another embodiment of the present disclosure may include the steps of (a) preparing a graphite-resin composite, (b) applying the graphite-resin composite prepared in the step (a) to a first prepreg sheet and a second prepreg sheet, respectively, to form a graphite-resin composite layer, and (c) stacking and compression-molding the first prepreg sheet and the second prepreg sheet to face each other.

A method for manufacturing an ultra-light bipolar plate for a fuel cell according to another embodiment of the present disclosure may include the steps of (a) preparing a graphite-resin composite, (b) applying the graphite-resin composite prepared in the step (a) to a first prepreg sheet and a second prepreg sheet, respectively, to form a graphite-resin composite layer, and (c) providing a third prepreg sheet between the first prepreg sheet and the second prepreg sheet, and then performing stacking and compression molding.

A method for manufacturing an ultra-light bipolar plate for a fuel cell according to another embodiment of the present disclosure may include the steps of (a) preparing a graphite-resin composite, (b) applying the graphite-resin composite prepared in the step (a) to a first support and a second support, respectively, to form a graphite-resin composite layer, and (c) stacking and compression-molding the graphite-resin composite layer so that it is positioned on one surface and the other surface of one or more prepreg sheets, respectively, and then removing the first support and the second support.

A method for manufacturing an ultra-light bipolar plate for a fuel cell according to another embodiment of the present disclosure may include the steps of (a) preparing a graphite-resin composite, (b) applying the graphite-resin composite prepared in the step (a) to one surface of a prepreg sheet to form a graphite-resin composite layer, and (c) applying the graphite-resin composite prepared in the step (a) to the other surface of the prepreg sheet to form and compression-mold the graphite-resin composite layer.

A fuel cell according to another embodiment of the present disclosure is a fuel cell composed of a plurality of unit cells, and the respective unit cells include a membrane-electrode assembly, a gas diffusion layer disposed on one surface and the other surface of the membrane-electrode assembly, respectively, and a bipolar plate which is provided between the membrane-electrode assembly and the gas diffusion layer, and has a gasket formed thereon, wherein the bipolar plate includes a carbon fiber fabric layer made of one or more prepreg sheets and a graphite-resin composite layer coated and formed on at least one surface of the carbon fiber fabric layer, but may satisfy the weight condition of 0.035 to 0.090 g/cm² at a thickness of 0.20 to 0.45 mm.

As described above, the ultra-light bipolar plate for a fuel cell, the manufacturing method thereof, and the fuel cell including the same according to the embodiments of the present disclosure can implement a weight of 0.035 to 0.090 g/cm² at a thickness of 0.20 to 0.45 mm and greatly improve corrosion resistance while having excellent electrical conductivity and mechanical strength by coating and forming a graphite-resin composite layer on a carbon fiber fabric layer.

### BRIEF DESCRIPTION OF DRAWINGS

FIG. 1A is a perspective view showing an ultra-light bipolar plate for a fuel cell according to one embodiment of the present disclosure, and FIG. 1B is a cross-sectional view.

FIGS. 2 to 4 are cross-sectional views schematically showing an ultra-light bipolar plate for a fuel cell according to one embodiment of the present disclosure.

FIG. 5 is a view schematically showing the fiber direction and stacking of prepregs.

FIG. 6 is a schematic view showing an ultra-light bipolar plate for a fuel cell having micro through-holes formed therein.

FIGS. 7 and 8 are views schematically showing a method for manufacturing an ultra-light bipolar plate for a fuel cell according to another embodiment of the present disclosure.

FIGS. 9 and 10 are process charts for explaining a method for manufacturing an ultra-light bipolar plate for a fuel cell according to another embodiment of the present disclosure.

FIG. 11 is a view schematically showing a method for forming a gasket on an ultra-light bipolar plate for a fuel cell.

FIG. 12 is a view schematically showing a fuel cell to which an ultra-light bipolar plate for a fuel cell according to another embodiment of the present disclosure is applied.

### DETAILED DESCRIPTION OF THE INVENTION

Hereinafter, embodiments of the present disclosure are described in detail. However, the present disclosure is not limited to the embodiments disclosed below, but may be implemented in various different forms. The present embodiments are only provided to ensure that the disclosure of the present disclosure is complete and to more completely inform those skilled in the art of the content of the present disclosure.

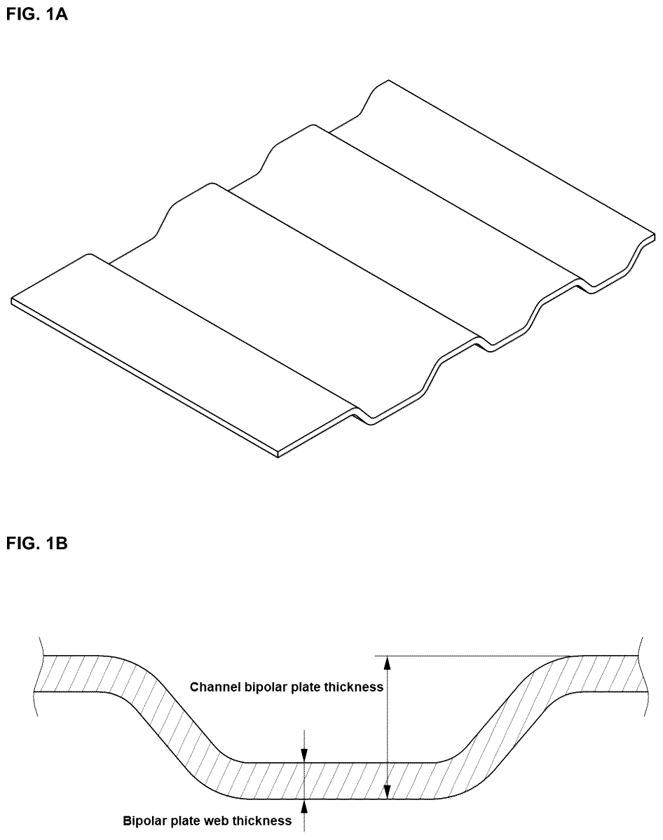

Meanwhile, the term ‘thin plate’ or ‘thin plate form’ referred to in the present disclosure is used to define the thin thickness of a bipolar plate manufactured of conventional metal, and it may refer to a thickness of 1.0 mm or less, and may refer to, for example, a thickness of 0.6 mm or less, in one embodiment of the present disclosure, a thickness of 0.45 mm or less. As shown in FIGS. 1A and 1B, the thickness of the bipolar plate is divided into the channel bipolar plate thickness and the web thickness, the channel thickness is variable portion depending on the design, and the thickness of the bipolar plate in this embodiment means the web thickness. However, the overall thickness of the bipolar plate (channel bipolar plate thickness) according to this embodiment also satisfies the above-mentioned range. In addition, ultra-light as referred to in the present disclosure may refer to satisfying the condition of a weight of less than 0.090 g/cm² at a thickness of 0.20 to 0.45 mm. Meanwhile, although graphite has a lower specific gravity than metal, it is thick and tends to be heavy, and such a problem was solved in this embodiment.

Hereinafter, an ultra-light bipolar plate for a fuel cell according to one embodiment of the present disclosure will be described in detail.

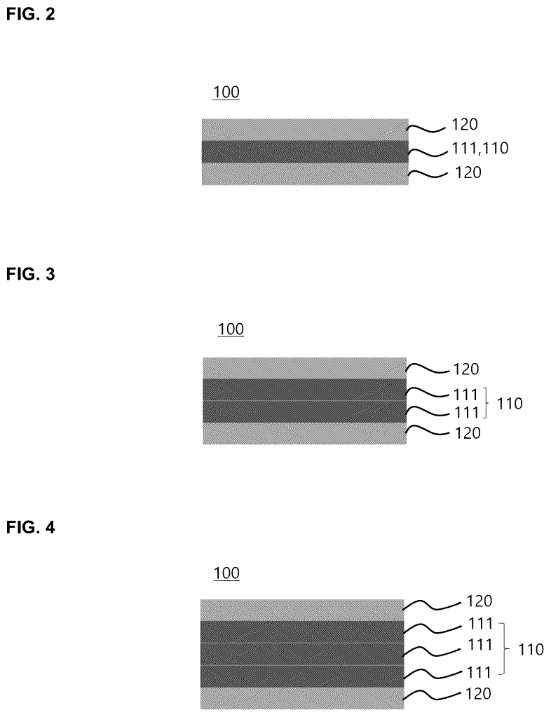

FIGS. 2 to 4, the ultra-light bipolar plate 100 for a fuel cell according to one embodiment of the present disclosure includes a carbon fiber fabric layer 110 and a graphite-resin composite layer 120, and the conditions of a weight 0.035 to 0.090 g/cm² and a density of 1.8 to 1.9 g/cm³ may be satisfied at a thickness of 0.20 to 0.45 mm. The ultra-light bipolar plate 100 of this embodiment can increase the web thickness twice (from 0.1 mm to 0.20 mm) compared to the metal bipolar plate, but insufficiently influences on the actual increase in stack volume, and since the ultra-light bipolar plate 100 has an effect of reducing the weight by 56% (from 0.08 g/cm² to 0.035 g/cm²), it can be applied to small transportation means such as drones and scooters to maximize weight reduction.

The carbon fiber fabric layer 110 is a layer provided to ensure strength and may be made of one or more prepreg sheets 111, where the prepreg sheet 111 may be one or more fibers selected from carbon fiber, forged carbon fiber, fabric-type carbon fiber, and glass fiber, which are impregnated with one or more resins selected from phenol, epoxy, vinyl ester, maleimide, polypropylene, polyvinylidene fluoride (PVDF), polyphenylene sulfide (PPS), polyethylene (PE), polyethylene terephthalate (PET), polyether ether ketone (PEEK), and polyphenylene oxide (PPO), and the carbon fiber fabric layer 110 with a diameter of satisfying 5 to 300 μm may be applied. Such a carbon fiber fabric layer 110 is formed to a thickness of 20 to 225 μm so that mechanical strength and penetration resistance can be secured. If the thickness thereof is less than 20 μm, not only it will be difficult to manufacture the prepreg sheet 111 having carbon fiber applied thereto, but also gas permeability and mechanical strength cannot be maintained, and if it exceeds 225 μm, the thickness becomes too thick, which is undesirable since there is a limit to securing penetration resistance (measurement of electrical conductivity in the thickness direction).

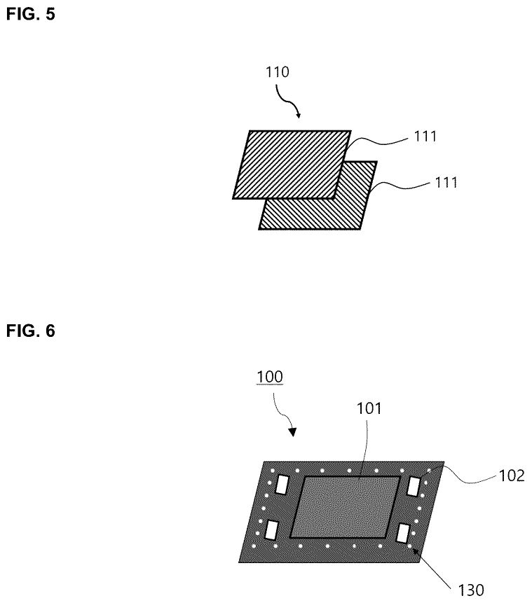

For example, the carbon fiber fabric layer 110 may be made of one prepreg sheet 111 as shown in FIG. 2, but it may be made of two or three prepreg sheets 111 as shown in FIGS. 3 and 4, and when two or more prepreg sheets 111 are stacked, it may be more advantageous in securing mechanical strength to stack and form them so that the fiber directions overlap in directions orthogonal to each other as shown in FIG. 5. Although not shown in the drawings, in this embodiment, 1 to 5 prepreg sheets 111 may be stacked and formed within a thickness of the carbon fiber fabric layer 110 of 225 μm.

The graphite-resin composite layer 120 is a layer which is provided to secure electrical conductivity by lowering the high penetration resistance of the carbon fiber fabric layer 110 by being coated and formed on at least one surface of the carbon fiber fabric layer 110. The graphite-resin composite layer 120 may be formed to a thickness of 0.02 mm to 0.5 mm, and if it has a thickness of less than 0.02 mm, it is difficult to secure electrical conductivity in the x-y direction, so there is a limit in its application in various fields, and if it exceeds 0.5 mm, it tends to break easily, so there is a problem of limitation in securing mechanical strength. Meanwhile, the graphite-resin composite layer 120 may be formed on at least one surface of the carbon fiber fabric layer 110 on which the channels are formed. Such a graphite-resin composite layer 120 may include 15 to 45% by weight of one or more resins selected from phenol, epoxy, vinyl ester, maleimide, polypropylene, polyvinylidene fluoride (PVDF), polyphenylene sulfide (PPS), polyethylene (PE), polyethylene terephthalate (PET), polyether ether ketone (PEEK), and polyphenylene oxide (PPO) and 55 to 85% by weight of one or more carbon composite material particles selected from natural graphite, flake graphite, highly crystalline graphite, microcrystalline graphite, expanded graphite, carbon nanotubes, graphene, carbon black, conductive carbon black, and carbon fiber, where the diameter of the carbon composite material particles may satisfy the range of 2 to 170 μm. As the weight of the carbon composite material particles increases, the strength increases, but since internal voids may occur at the same time and hydrogen permeability problems may occur, it is desirable to satisfy the above-mentioned numerical range, and the diameter range of the carbon composite material particles may secure the same strength in all regions of the graphite-resin composite layer 120 in a numerical value range that may be more evenly and widely distributed within the resin.

One method selected from a bar coater, a lip die coater, a slot die coater, and a spray coater may be applied as coating.

Meanwhile, the ultra-light bipolar plate 100 for a fuel cell may further include a plurality of micro through-holes 130 to further facilitate gasket forming, and these micro through-holes 130 may be formed to be spaced apart from each other at predetermined intervals along the border of the bipolar plate for a fuel cell 100 as shown in FIG. 6. For example, the micro through-holes 130 may have a long side diameter of 3 mm or less, preferably 1 to 3 mm.

For example, the micro through-holes 130 may be formed in the outer side than the bipolar plate penetration parts 102. For example, the formation position of the micro through-holes 130 are located on the same line as the formation position of the gasket 150, and it goes without saying that the formation positions of the micro through-holes 130 can be adjusted depending on the shape or forming position of the gasket 150. Conventionally manufactured bipolar plates made of graphite were unable to form micro through-holes 130 due to poor mechanical strength when manufactured in a thin plate form such as the ultra-light bipolar plate 100 for a fuel cell of the present disclosure, but since it is possible to form micro through-holes 130 even when the thin plate-type ultra-light bipolar plate 100 is manufactured by forming the graphite-resin composite layer 120 according to one embodiment of the present disclosure, the efficiency of the manufacturing process can be greatly improved.

Hereinafter, a method for manufacturing an ultra-light bipolar plate for a fuel cell according to another embodiment of the present disclosure will be described in detail. Specific descriptions of the contents that overlap with the ultra-light bipolar plate for a fuel cell will be omitted.

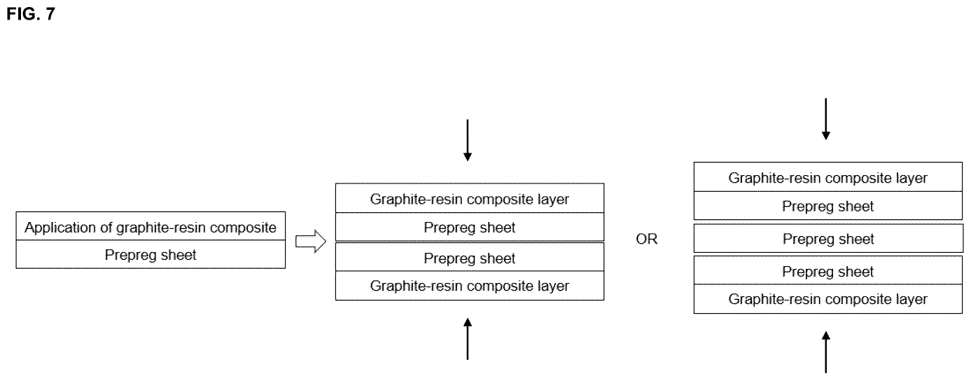

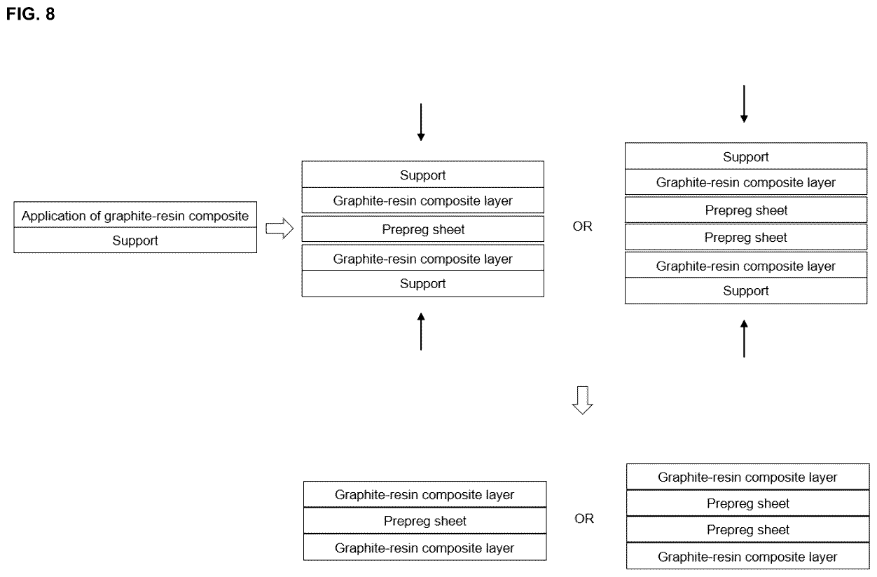

Referring to FIGS. 7 and 8, the method for manufacturing an ultra-light bipolar plate for a fuel cell in this embodiment may include a method for forming a graphite-resin composite layer by directly applying a graphite-resin composite to a prepreg sheet and a method for applying a graphite-resin composite layer to a support to form a graphite-resin composite layer and then bonding it to a prepreg sheet, which can be appropriately selected and applied depending on the work situation and purpose.

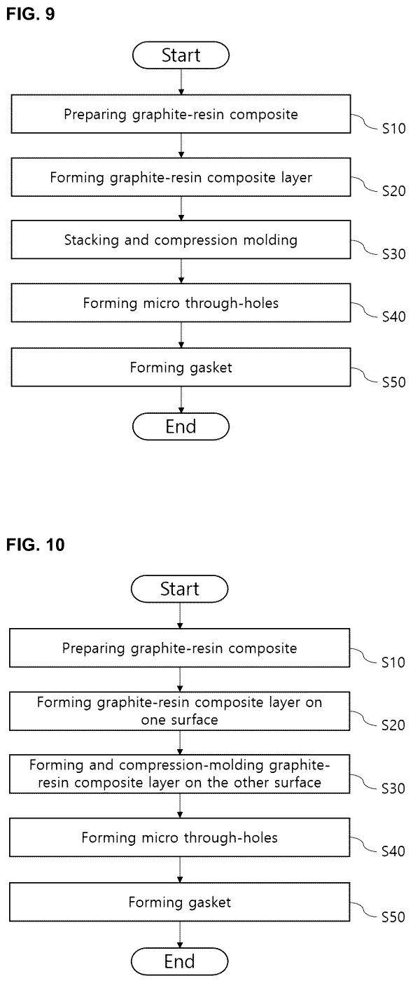

As shown in FIGS. 7 to 10, the method for manufacturing a bipolar plate for a fuel cell, in which direct application is to a prepreg sheet, may include the steps of preparing a graphite-resin composite S10, applying the graphite-resin composite prepared in the step S10 to a first prepreg sheet and a second prepreg sheet, respectively, to form a graphite-resin composite layer S20, and stacking and compression-molding the first prepreg sheet and the second prepreg sheet to face each other S30. Furthermore, it may include the steps of preparing a graphite-resin composite S10, applying the graphite-resin composite prepared in the step S10 to a first prepreg sheet and a second prepreg sheet, respectively, to form a graphite-resin composite layer S20, and providing a third prepreg sheet between the first prepreg sheet and the second prepreg sheet, and then performing stacking and compression molding S30.

As described above, since the reason for performing the step S20 before the step S30 is that when the liquid graphite-resin composite is applied after stacking of the prepreg sheets, the graphite-resin composite layer is formed to an uneven thickness so that additional work for uniformizing the graphite-resin composite layer should be performed, there is a problem in that work process becomes complicated and costs increase. Therefore, in order to simplify the process and ensure thickness uniformity, it is desirable to apply the graphite-resin composite to one prepreg sheet to form a graphite-resin composite layer, and then perform stacking.

The method for manufacturing a bipolar plate for a fuel cell, to which a support is applied, may include the steps of preparing a graphite-resin composite S10, applying the graphite-resin composite prepared in the step S10 to a first support and a second support, respectively, to form a graphite-resin composite layer S20, and stacking and compression-molding the graphite-resin composite layer so that it is positioned on one surface and the other surface of one or more prepreg sheets, respectively, and then removing the first support and the second support S30.

Meanwhile, direct application may be applied to one surface and the other surface of the prepreg sheet to manufacture the bipolar plate for a fuel cell, thereby forming the bipolar plate to a thinner thickness. Referring to FIG. 10, such a method for manufacturing a bipolar plate for a fuel cell may include the steps of preparing a graphite-resin composite S10, applying the graphite-resin composite prepared in the step S10 to one surface of a prepreg sheet to form a graphite-resin composite layer S20, and applying the graphite-resin composite prepared in the step S10 to the other surface of the prepreg sheet to form and compression-mold the graphite-resin composite layer S30. In the above-described method, the stacking step can be omitted, and the spray coating method may be applied as an application method.

For example, the graphite-resin composite in the step S10 may be prepared by stirring 15 to 45% by weight of one or more resins selected from phenol, epoxy, vinyl ester, maleimide, polypropylene, polyvinylidene fluoride, polyphenylene sulfide, polyethylene, polyethylene terephthalate, polyether ether ketone, and polyphenylene oxide and 55 to 85% by weight of one or more carbon composite material particles selected from natural graphite, flake graphite, highly crystalline graphite, microcrystalline graphite, expanded graphite, carbon nanotubes, graphene, carbon black, conductive carbon black, and carbon fiber at a temperature of 70° C. to 90° C. at 10 to 20 rpm for 20 to 40 minutes. If the temperature is less than 70° C., the resin does not melt sufficiently, so it may be difficult to mix evenly with the carbon composite material particles, and if the temperature exceeds 90° C., the effect may not be that great due to the temperature condition not less than the temperature required. Coating in the step S20 may be performed using a method selected from a bar coater, a lip die coater, a slot die coater, and a spray coater, and compression molding in the step S30 may be performed at 200 to 300° C. and 7 to 90 MPa, which are relatively high temperature and high pressure compared to a conventional method.

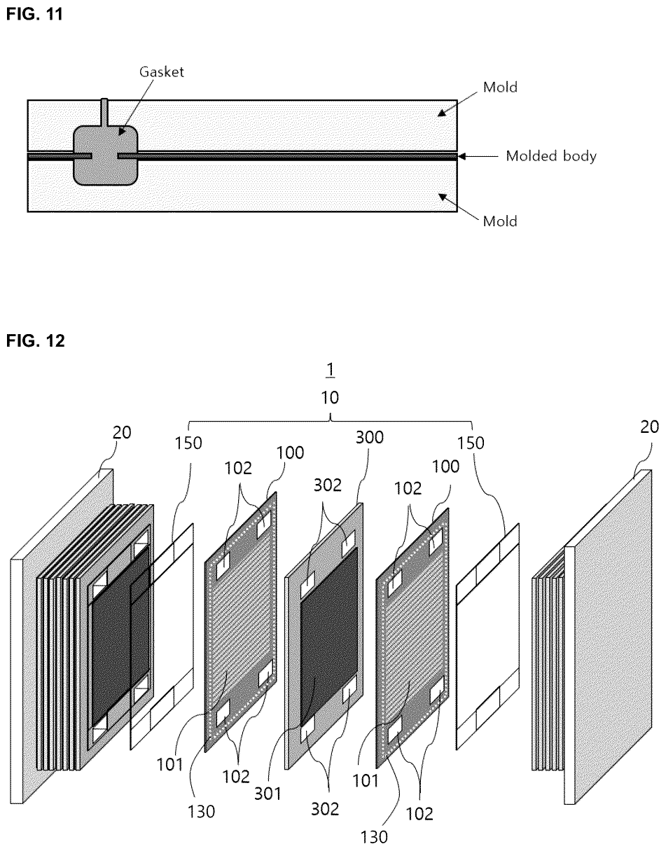

After the step S30, the method may further include a step S40 of forming a plurality of micro through-holes in the compression-molded body, and a step S50 of setting the molded body in a mold as shown in FIG. 11 and injecting a gasket composition at a position corresponding to the plurality of micro through-holes to form the gasket. When the gasket composition is put into the hole of the mold, the gasket may be formed on both surfaces of the molded body while the gasket composition moves to the opposite surface through the micro through-holes. For example, in order to improve sealing force through the synergistic effect of physical and chemical compression forces, it is preferable that the gasket composition includes 45 to 75% by weight of one or more polymer bases selected from acrylonitrile butadiene rubber (NBR), ethylene propylene diene monomer rubber (EPDM), methyl-vinyl silicone rubber (VMQ), fluoroelastomers (FKM), and fluorosilicone rubber (FVMQ), and 25 to 55% by weight of one or more carbon composite material particles selected from natural graphite, flake graphite, highly crystalline graphite, microcrystalline graphite, expanded graphite, carbon nanotubes, graphene, carbon black, conductive carbon black, and carbon fiber. In addition, since the gasket is formed integrally, the sealing force may be further improved compared to the existing one.

For example, a step of hydrophilic treatment of the molded body may be further performed between the steps S30 and S40. In this embodiment, hydrophilic treatment may be performed by applying one or more methods selected from inorganic chemical treatment, organic chemical treatment, and light treatment. Inorganic chemical treatment may be performed by dissolving TiO₂, SnO₂ or graphene in a solvent and coating the surface, or vacuum-impregnating it, organic chemical treatment may be performed by applying silicon or acryl, and light treatment may be performed by applying UV, laser, or plasma.

Hereinafter, a fuel cell according to another embodiment of the present disclosure will be described in detail.

Referring to FIG. 12, the fuel cell 1 including an ultra-light bipolar plate is a fuel cell 1 composed of a plurality of unit cells 10, and the respective unit cells 10 include a membrane-electrode assembly 300, a gas diffusion layer 301 disposed on one surface and the other surface of the membrane-electrode assembly 300, respectively, and a bipolar plate 100 which is provided between the membrane-electrode assembly 300 and the gas diffusion layer 301, and on which a gasket 150 is formed, wherein the bipolar plate 100 includes a carbon fiber fabric layer 110 made of one or more prepreg sheets and a graphite-resin composite layer 120 coated and formed on at least one surface of the carbon fiber fabric layer 110, but may satisfy the weight condition of 0.035 to 0.090 g/cm² at a thickness of 0.20 to 0.45 mm.

### Experimental Example 1: Evaluation of Physical and Chemical Properties

In order to compare and evaluate the physical and chemical properties of Example 1, the ultra-light bipolar plate for a fuel cell according to the present disclosure, and stainless steel, titanium, aluminum, and graphite, density, thickness, and weight per area were measured as follows, and the results are shown in Table 1.

TABLE 1

| | Density | Thickness | Weight per area |
|---|---|---|---|
| Classification | (g/cm³) | (mm) | (g/cm²) |
| Example 1 | 1.7 | 0.20 to 0.45 | 0.035 to 0.090 |
| Stainless steel | 8.0 | 0.1 | 0.08 |
| (SUS) | | | |
| Titanium (Ti) | 4.5 | 0.5 | 0.23 |
| Aluminum (Al) | 2.7 | 0.5 | 0.14 |
| Graphite | 2.25 | 1.5 | 0.35 |

Referring to Table 1, it could be confirmed that Example 1 not only could be manufactured in the form of a thin plate with a thickness similar to that of stainless steel, titanium, and aluminum, but also had significantly reduced weight compared to graphite. In addition, Example 1 also had a lower density than those of other metals, so it could be found that the weight of Example 1 was lightened.

Although exemplary embodiments of the present disclosure have been described in detail above, the scope of rights of the present disclosure is not limited thereto, and various modifications and improved forms made by those skilled in the art using the basic concept of the present disclosure defined in the following claims also fall within the scope of the rights of the present disclosure.

All technical terms used in the present disclosure, unless otherwise defined, are used with the same meaning as commonly understood by a person skilled in the art in the field related to the present disclosure. The contents of all publications described as reference documents in this specification are introduced into the present disclosure.

### EXPLANATION OF REFERENCE NUMERALS

1: Fuel cell
10: Unit cell
20: End plate
100: Bipolar plate for fuel cell
101: Bipolar plate flow path
102: Bipolar plate penetration part
110: Carbon fiber fabric layer
111: Prepreg sheet
120: Graphite-resin composite layer
130: Micro through-hole
150: Gasket
300: Membrane-electrode assembly penetration part
301: Gas diffusion layer
302: Membrane-electrode assembly

1. An ultra-light bipolar plate for a fuel cell, comprising:
a carbon fiber fabric layer made of one or more prepreg sheets; and
a graphite-resin composite layer coated and formed on at least one surface of the carbon fiber fabric layer.

2. The ultra-light bipolar plate for a fuel cell of claim 1, satisfying the weight condition of 0.035 to 0.090 g/cm² at a thickness of 0.20 to 0.45 mm.

3. The ultra-light bipolar plate for a fuel cell of claim 1, wherein the prepreg sheet 111 is one or more fibers selected from carbon fiber, forged carbon fiber, fabric-type carbon fiber, and glass fiber, which are impregnated with one or more resins selected from phenol, epoxy, vinyl ester, maleimide, polypropylene, polyvinylidene fluoride, polyphenylene sulfide, polyethylene, polyethylene terephthalate, polyether ether ketone, and polyphenylene oxide.

4. The ultra-light bipolar plate for a fuel cell of claim 1, wherein the graphite-resin composite layer comprises 15 to 45% by weight of one or more resins selected from phenol, epoxy, vinyl ester, maleimide, polypropylene, polyvinylidene fluoride, polyphenylene sulfide, polyethylene, polyethylene terephthalate, polyether ether ketone, and polyphenylene oxide and 55 to 85% by weight of one or more carbon composite material particles selected from natural graphite, flake graphite, highly crystalline graphite, microcrystalline graphite, expanded graphite, carbon nanotubes, graphene, carbon black, conductive carbon black, and carbon fiber.

5. A method for manufacturing an ultra-light bipolar plate for a fuel cell, comprising the steps of:
(a) preparing a graphite-resin composite; and
(b) applying the graphite-resin composite prepared in the step (a) to a first prepreg sheet and a second prepreg sheet, respectively, to form a graphite-resin composite layer.

6. The method of claim 5, wherein the graphite-resin composite in the step (a) is prepared by stirring 15 to 45% by weight of one or more resins selected from phenol, epoxy, vinyl ester, maleimide, polypropylene, polyvinylidene fluoride, polyphenylene sulfide, polyethylene, polyethylene terephthalate, polyether ether ketone, and polyphenylene oxide and 55 to 85% by weight of one or more carbon composite material particles selected from natural graphite, flake graphite, highly crystalline graphite, microcrystalline graphite, expanded graphite, carbon nanotubes, graphene, carbon black, conductive carbon black, and carbon fiber at a temperature of 70° C. to 90° C. at 10 to 20 rpm for 20 to 40 minutes.

7. The method of claim 5, after the step (b), further comprising the step of:
(c) stacking and compression-molding the first prepreg sheet and the second prepreg sheet to face each other.

8. The method of claim 7, after the step (c), further comprising the steps of:
(d) forming a plurality of micro through-holes in the molded body compression-molded in the step (c); and
(e) setting the molded body in a mold and injecting a gasket composition at a position corresponding to the plurality of micro through-holes to form the gasket;
wherein the gasket composition in the step (e) comprises 45 to 75% by weight of one or more polymer bases selected from acrylonitrile butadiene rubber, ethylene propylene diene monomer rubber, methyl-vinyl silicone rubber, fluoroelastomers, and fluorosilicone rubber, and 25 to 55% by weight of one or more carbon composite material particles selected from natural graphite, flake graphite, highly crystalline graphite, microcrystalline graphite, expanded graphite, carbon nanotubes, graphene, carbon black, conductive carbon black, and carbon fiber.

9. The method of claim 5, after the step (b), further comprising the step of:
(c) providing a third prepreg sheet between the first prepreg sheet and the second prepreg sheet, and then performing stacking and compression molding.

10. The method of claim 9, after the step (c), further comprising the steps of:
(d) forming a plurality of micro through-holes in the molded body compression-molded in the step (c); and
(e) setting the molded body in a mold and injecting a gasket composition at a position corresponding to the plurality of micro through-holes to form the gasket;
wherein the gasket composition in the step (e) comprises 45 to 75% by weight of one or more polymer bases selected from acrylonitrile butadiene rubber, ethylene propylene diene monomer rubber, methyl-vinyl silicone rubber, fluoroelastomers, and fluorosilicone rubber, and 25 to 55% by weight of one or more carbon composite material particles selected from natural graphite, flake graphite, highly crystalline graphite, microcrystalline graphite, expanded graphite, carbon nanotubes, graphene, carbon black, conductive carbon black, and carbon fiber.

11. A method for manufacturing an ultra-light bipolar plate for a fuel cell, comprising the steps of:
(a) preparing a graphite-resin composite;
(b) applying the graphite-resin composite prepared in the step (a) to a first support and a second support, respectively, to form a graphite-resin composite layer; and
(c) stacking and compression-molding the graphite-resin composite layer so that it is positioned on one surface and the other surface of one or more prepreg sheets, respectively, and then removing the first support and the second support.

12. The method of claim 11, wherein the graphite-resin composite in the step (a) is prepared by stirring 15 to 45% by weight of one or more resins selected from phenol, epoxy, vinyl ester, maleimide, polypropylene, polyvinylidene fluoride, polyphenylene sulfide, polyethylene, polyethylene terephthalate, polyether ether ketone, and polyphenylene oxide and 55 to 85% by weight of one or more carbon composite material particles selected from natural graphite, flake graphite, highly crystalline graphite, microcrystalline graphite, expanded graphite, carbon nanotubes, graphene, carbon black, conductive carbon black, and carbon fiber at a temperature of 70° C. to 90° C. at 10 to 20 rpm for 20 to 40 minutes.

13. The method of claim 11, after the step (c), further comprising the steps of:
(d) forming a plurality of micro through-holes in the molded body compression-molded in the step (c); and
(e) setting the molded body in a mold and injecting a gasket composition at a position corresponding to the plurality of micro through-holes to form the gasket;
wherein the gasket composition in the step (e) comprises 45 to 75% by weight of one or more polymer bases selected from acrylonitrile butadiene rubber, ethylene propylene diene monomer rubber, methyl-vinyl silicone rubber, fluoroelastomers, and fluorosilicone rubber, and 25 to 55% by weight of one or more carbon composite material particles selected from natural graphite, flake graphite, highly crystalline graphite, microcrystalline graphite, expanded graphite, carbon nanotubes, graphene, carbon black, conductive carbon black, and carbon fiber.

14. A method for manufacturing an ultra-light bipolar plate for a fuel cell, comprising the steps of:
(a) preparing a graphite-resin composite;
(b) applying the graphite-resin composite prepared in the step (a) to one surface of a prepreg sheet to form a graphite-resin composite layer; and
(c) applying the graphite-resin composite prepared in the step (a) to the other surface of the prepreg sheet to form and compression-mold the graphite-resin composite layer.

15. The method of claim 14, wherein the graphite-resin composite in the step (a) is prepared by stirring 15 to 45% by weight of one or more resins selected from phenol, epoxy, vinyl ester, maleimide, polypropylene, polyvinylidene fluoride, polyphenylene sulfide, polyethylene, polyethylene terephthalate, polyether ether ketone, and polyphenylene oxide and 55 to 85% by weight of one or more carbon composite material particles selected from natural graphite, flake graphite, highly crystalline graphite, microcrystalline graphite, expanded graphite, carbon nanotubes, graphene, carbon black, conductive carbon black, and carbon fiber at a temperature of 70° C. to 90° C. at 10 to 20 rpm for 20 to 40 minutes.

16. The method of claim 14, after the step (c), further comprising the steps of:
(d) forming a plurality of micro through-holes in the molded body compression-molded in the step (c); and
(e) setting the molded body in a mold and injecting a gasket composition at a position corresponding to the plurality of micro through-holes to form the gasket;
wherein the gasket composition in the step (e) comprises 45 to 75% by weight of one or more polymer bases selected from acrylonitrile butadiene rubber, ethylene propylene diene monomer rubber, methyl-vinyl silicone rubber, fluoroelastomers, and fluorosilicone rubber, and 25 to 55% by weight of one or more carbon composite material particles selected from natural graphite, flake graphite, highly crystalline graphite, microcrystalline graphite, expanded graphite, carbon nanotubes, graphene, carbon black, conductive carbon black, and carbon fiber.

17. A fuel cell is a fuel cell composed of a plurality of unit cells, the respective unit cells comprising:
a membrane-electrode assembly;
a gas diffusion layer disposed on one surface and the other surface of the membrane-electrode assembly, respectively; and
a bipolar plate which is provided between the membrane-electrode assembly and the gas diffusion layer, and has a gasket formed thereon,
wherein the bipolar plate comprises: a carbon fiber fabric layer made of one or more prepreg sheets; and a graphite-resin composite layer coated and formed on at least one surface of the carbon fiber fabric layer, but satisfies the weight condition of 0.035 to 0.090 g/cm² at a thickness of 0.20 to 0.45 mm.
